(19) United States
(12) Patent Application Publication
(10) Pub. No.: US 2010/0253705 A1
(43) Pub. Date: Oct. 7, 2010

(54) BACKLIGHT DEVICE AND DISPLAY DEVICE

(75) Inventor: Yasutoshi Maeda, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/677,894

(22) PCT Filed: May 14, 2008
(86) PCT No.: PCT/JP2008/058837

§ 371 Date: Mar. 12, 2010

(30) Foreign Application Priority Data
Sep. 13, 2007 (JP) 2007-237699

(51) Int. Cl. G09G 5/10

(52) U.S. Cl. 345/690; 345/102

(57) ABSTRACT

In a backlight device (3) including cold cathode fluorescent tubes (discharge tubes) (20, 21) and a chassis (12) for containing the cold cathode fluorescent tubes (20, 21), the chassis (12) includes a metal chassis part (12a) made of metal and a resin chassis part (12b) made of a synthetic resin. Further, the metal chassis part (12a) is used for a section of the chassis (12) including a predetermined distance from an inverter circuit (driving circuit) (26) for the cold cathode fluorescent tubes (20, 21) in the longitudinal direction of the cold cathode fluorescent tubes (20, 21) and the resin chassis part (12b) is used for the section beyond the predetermined distance.

### TECHNICAL FIELD

The present invention relates to a backlight device, and in particular to a backlight device using a discharge tube such as a cold cathode fluorescent tube and a display device using the backlight device.

### BACKGROUND ART

In recent years, for example, liquid crystal display devices have been used widely in liquid crystal televisions, monitors, mobile telephones, and the like as flat panel displays having advantages such as smaller thinness and lighter weight compared with those of conventional Braun tubes. Such liquid crystal display devices each include an illumination device (backlight device) for emitting light and a liquid crystal panel for displaying a desired image by playing a role as a shutter with respect to light from a light source provided in the backlight device.

Furthermore, the backlight devices can be classified roughly into a direct type and an edge-light type depending upon the arrangement of the light source with respect to the liquid crystal panel. In a liquid crystal display device including a liquid crystal panel of 20 inches or more, the direct type backlight device is used generally because it can facilitate an increase in brightness and size compared with the edge-light type. More specifically, the direct type backlight device has a configuration in which a plurality of linear light sources are placed on the back (non-display surface) side of the liquid crystal panel, and the linear light sources can be placed on the immediately reverse side of the liquid crystal panel, so that a large number of linear light sources can be used. For these reasons, the direct type backlight device is likely to have high brightness and is suited for increasing the brightness and the size. Furthermore, the direct type backlight device has a hollow structure and therefore is light-weight even if its size is increased. In this regard, the direct type backlight device is suited for increasing the brightness and the size.

Further, the direct type backlight device is provided with cold cathode fluorescent tubes as the plurality of linear light sources and inverter circuits for lighting and driving the respective cold cathode fluorescent tubes, as described in JP 2002-231034 A, for example. The backlight device outputs, to the liquid crystal panel, planer illumination light from a light emitting surface placed so as to oppose the liquid crystal panel.

### DISCLOSURE OF INVENTION

### Problem to be Solved by the Invention

By the way, in a conventional backlight device as described above, normally, the plurality of cold cathode fluorescent tubes are contained in a chassis made of metal.

However, in the conventional backlight device, parasitic capacitance present between the cold cathode fluorescent tube (discharge tube) and the chassis causes leakage current. Therefore, in the conventional backlight device, a lamp current running through inside the cold cathode fluorescent tube declines as distance away from the inverter circuit (driving circuit), causing a brightness gradient in which the brightness declines. In other words, in the conventional backlight device, the brightness of the planer illumination light may decline significantly as distance away from the inverter circuit, causing difficulty in making the brightness of the illumination light uniform.

With the foregoing in mind, it is an object of the present invention to provide a backlight device capable of inhibiting the occurrence of a brightness gradient resulting from a leakage current and of making the brightness of illumination light uniform with ease, and a display device using the backlight device.

### Means for Solving Problem

In order to achieve the above-mentioned object, the backlight device of the present invention includes: a discharge tube; a chassis for containing the discharge tube; and a driving circuit connected to the discharge tube to light and drive the discharge tube. The chassis includes a metal chassis part made of metal and a resin chassis part made of a synthetic resin, the metal chassis part is used for a section of the chassis including a predetermined distance from the driving circuit in a longitudinal direction of the discharge tube, and the resin chassis part is used for a section of the chassis beyond the predetermined distance.

In the chassis of the backlight device having the above configuration, the metal chassis part made of metal is used for the section including the predetermine distance from the driving circuit in the longitudinal direction of the discharge lamp, and the resin chassis part made of a synthetic resin is used for the section beyond the predetermined distance. Thus, it is possible to prevent the occurrence of a leakage current in the resin chassis part, in other words, in the section beyond the predetermined distance. As a result, a brightness gradient resulting from the leakage current can be inhibited and the brightness of illumination light can be made uniform with ease.

Further, in the above-described backlight device, the driving circuits are respectively connected to both ends of the discharge tube, the resin chassis part is used for a middle section of the chassis in the longitudinal direction of the discharge tube, and the metal chassis parts are used for both end sides of the discharge tube so as to interpose the resin chassis part.

In this case, even when a long discharge tube is used, it is possible to prevent the occurrence of the leakage current in the middle section in the longitudinal direction with certainty and also a decline in the brightness in the middle section resulting from the brightness gradient can be prevented with ease.

Further, in the above-described backlight device, in the chassis, a shape of the metal chassis part and a shape of the resin chassis part are defined by using a temperature distribution in the chassis during the backlight device is in active use.

In this case, fluctuations in the light emission efficient caused by the ambient temperature of the discharge tube can be inhibited, so that illumination light with uniform brightness can be obtained.

Further, in the above-described backlight device, a cold cathode fluorescent tube is used for the discharge tube, and the discharge tube is placed so that the longitudinal direction thereof becomes parallel to a direction perpendicular to a direction of gravity.

In this case, mercury (vapor) charged in the cold cathode fluorescent tube is prevented from leaning to one side, so that a reduction in the life span of the cold cathode fluorescent tube can be prevented significantly.

Further, the display device of the present invention uses the backlight device having any one of the above-described configurations.

Since the display device having the above configuration uses the backlight device capable of inhibiting the brightness gradient resulting from the leakage current and of making the brightness of illumination light uniform with ease, the display device having excellent display quality can be formed with ease.

### EFFECT OF THE INVENTION

According to the present invention, it is possible to provide a backlight device capable of inhibiting the occurrence of a brightness gradient resulting from a leakage current and of making the brightness of illumination light uniform with ease, and a display device using the backlight device.

### BRIEF DESCRIPTION OF DRAWINGS

FIG. 1 is a schematic cross-sectional view for explaining a backlight device and a liquid crystal display device according to Embodiment 1 of the present invention.

FIG. 2 is a plan view for explaining a chassis and pseudo U-shaped tubes provided in the backlight device.

FIG. 3 is a block diagram showing a driving circuit for the pseudo U-shaped tubes in a concretive manner.

FIGS. 4A to 4C are diagrams for explaining effects of the chassis. FIG. 4A is a plan view showing a specific configuration of the chassis, FIGS. 4B and 4C are graphs showing a brightness distribution and a temperature distribution in the backlight device, respectively.

FIG. 5 is a plan view for explaining a chassis and cold cathode fluorescent tubes in a backlight device according to Embodiment 2 of the present invention.

FIG. 6 is a block diagram showing driving circuits for the cold cathode fluorescent tube in a concretive manner.

FIGS. 7A to 7C are diagrams for explaining effects of the chassis shown in FIG. 5. FIG. 7A is a plan view showing a specific configuration of the chassis, FIGS. 7B and 7C are graphs showing a brightness distribution and a temperature distribution in the backlight device shown in FIG. 5, respectively.

FIG. 8 is a plan view for explaining a chassis of a backlight device according to Embodiment 3 of the present invention.

### DESCRIPTION OF THE INVENTION

Hereinafter, preferred embodiments of a backlight device and a display device using the backlight device of the present invention will be described with reference to the drawings. In the following description, a case where the present invention is applied to a transmissive liquid crystal display device will be described as an example. Further, the dimensions of the components in each of the drawings do not necessarily indicate the actual dimensions of the components and dimensional ratios among the respective components and the like.

### Embodiment 1

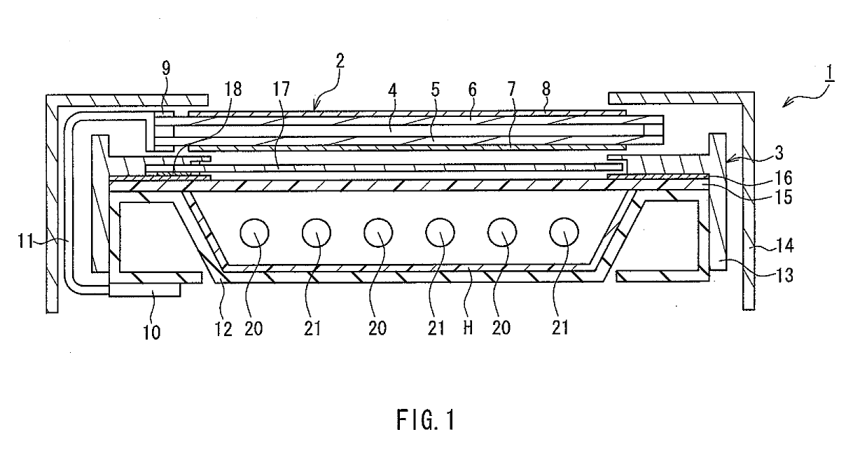

FIG. 1 is a schematic cross-sectional view for explaining a backlight device and a liquid crystal display device according to Embodiment 1 of the present invention. As shown in the drawing, in the liquid display device 1 of the present embodiment, a liquid crystal panel 2 as a display portion is placed such that its visual recognition side (display surface side) faces the topside in the drawing and a backlight device 3 of the present invention for emitting illumination light to illuminate the liquid crystal panel 2 is placed on the non-display surface side (bottom side in the drawing) of the liquid crystal panel 2.

The liquid crystal panel 2 includes a liquid crystal layer 4, a pair of transparent substrates 5 and 6 between which the liquid crystal layer 4 is interposed and polarizers 7 and 8 provided respectively on the outer surfaces of the transparent substrates 5 and 6. Further, the liquid crystal panel 2 includes a driver 9 for driving the liquid crystal panel 2 and a driving circuit device 10 connected to the driver 9 through a flexible printed board 11, so that in the liquid crystal panel 2, the liquid crystal layer 4 can be driven by the pixel. And in the liquid crystal panel 2, a desired image is displayed by the liquid crystal layer 4 modulating the polarization state of the illumination light that entered therein through the polarizer 7 and controlling the amount of the light that passes through the polarizer 8.

The backlight device 3 includes a bottomed chassis 12 whose upper side in the drawing (the liquid crystal panel 2 side) is opened, and a frame 13 placed on the liquid crystal panel 2 side of the chassis 12. Further, the chassis 12 and the frame 13 are made of metal or a synthetic resin and are interposed with a bezel 14 in an L-shape in cross-section while the liquid crystal panel 2 is placed above the frame 13. In this manner, the backlight device 3 is combined with the liquid crystal panel 2 and is integrated therewith as the transmission type liquid crystal display device 1 in which the illumination light from the backlight device 3 enters the liquid crystal panel 2.

As will be described later in detail, the chassis 12 includes a metal chassis part and a resin chassis part. Thus, the occurrence of a leakage current resulting from parasitic capacitance is adjusted to an adequate amount in the backlight device 3 so as to make the brightness of the illumination light uniform.

The backlight device 3 further includes a diffusion plate 15 placed so as to cover the opening of the chassis 12 and an optical sheet 17 placed above the diffusion plate 15 on the liquid crystal panel 2 side. Furthermore, the backlight device 3 includes, for example, three sets of pseudo U-shaped tubes (described later) in the chassis 12. Each of these pseudo U-shaped tubes includes a pair of cold cathode fluorescent tubes 20 and 21. Light from each of the cold cathode fluorescent tubes 20 and 21 is outputted as the illumination light from the light emitting surface of the backlight device 3 placed to oppose the liquid crystal panel 2.

The diffusion plate 15 is made of, for example, a synthetic resin or a glass material in a rectangular shape with a thickness of about 2 mm, and diffuses light from the cold cathode fluorescent tubes 20 and 21 and outputs the diffused light to the optical sheet 17 side. Furthermore, the four sides of the diffusion plate 15 are mounted on a frame-shaped surface provided on the upper side of the chassis 12, and thus the diffusion plate 15 is incorporated in the backlight device 3 while being interposed between the frame-shaped surface of the chassis 12 and the inner surface of the frame 13 through an elastically-deformable pressure member 16. Furthermore, the diffusion plate 15 is supported, at a substantially central portion thereof, by a transparent support member (not shown) provided in the chassis 12, and is prevented from being bent toward the inner side of the chassis 12.

Further, the diffusion plate 15 is held movably between the chassis 12 and the pressure member 16. Thus, even when expansion (plastic) deformation occurs to the diffusion plate 15 due to an influence of heat, such as heat generated by the cold cathode fluorescent tubes 20 and 21 or an increase in the temperature inside the chassis 12, the plastic deformation is absorbed by the pressure member 16 deforming elastically, whereby a decrease in the diffusibility of light from the cold cathode fluorescent tubes 20 and 21 is minimized. It is preferred to use the diffusion plate 15 made of a glass material having high heat resistance than of a synthetic resin because warpage, yellowing, thermal deformation, and the like caused by the above influence of heat are unlikely to occur.

The optical sheet 17 includes a light-gathering sheet formed of, for example, a synthetic resin film with a thickness of about 0.5 mm, and is configured to increase the brightness of the illumination light to the liquid crystal panel 2. Furthermore, known optical sheet materials such as a prism sheet, a diffusion sheet and a polarization sheet for improving the display quality on the display surface of the liquid crystal panel 2 are laminated on the optical sheet 17 as needed. And the optical sheet 17 is configured to convert light outputted from the diffusion plate 15 into planer light having a predetermined brightness (e.g., 10000 cd/m²) or more and a uniform brightness and allows the planer light to enter the liquid crystal panel 2 side as illumination light. Alternatively, an optical member, such as a diffusion sheet for adjusting the viewing angle of the liquid crystal panel 2, may be laminated appropriately, for example, on the upper side (display surface side) of the liquid crystal panel 2.

For example, at the center of the left end side in FIG. 1, which is to be the upper side during the actual use of the liquid crystal display device 1, a protrusion sticking out towards the left side in the drawing is formed on the optical sheet 17. And only the protrusion of the optical sheet 17 is interposed between the inner surface of the frame 13 and the pressure member 16 through an elastic material 18. The optical sheet 17 is incorporated in the backlight device 3 in an expandable state. Thus, even when expansion (plastic) deformation occurs to the optical sheet 17 due to the influence of heat such as heat generated by the cold cathode fluorescent tubes 20 and 21 and the like, free expansion deformation mainly in the protrusion becomes possible, whereby the occurrence of wrinkles, bending, and the like in the optical sheet 17 can be minimized. As a result, in the liquid crystal display device 1, a deterioration in the display quality of the display surface of the liquid crystal panel 2, such as unevenness in brightness resulting from the bending and the like of the optical sheet 17, can be minimized.

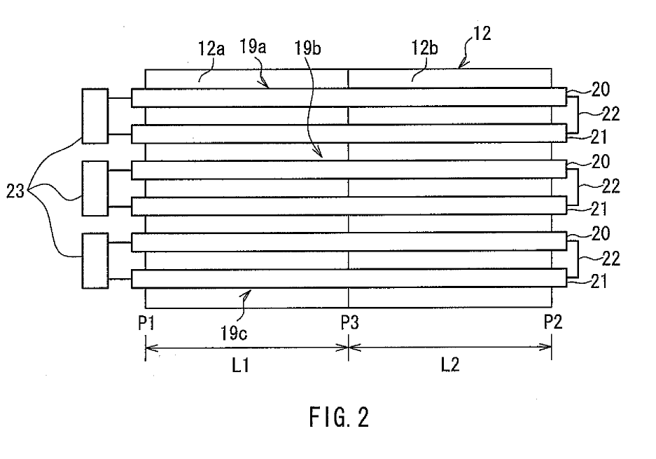

Hereinafter, the chassis 12 and the pseudo U-shaped tubes in the backlight device 3 of the present embodiment will be described with reference to FIGS. 2 to 4.

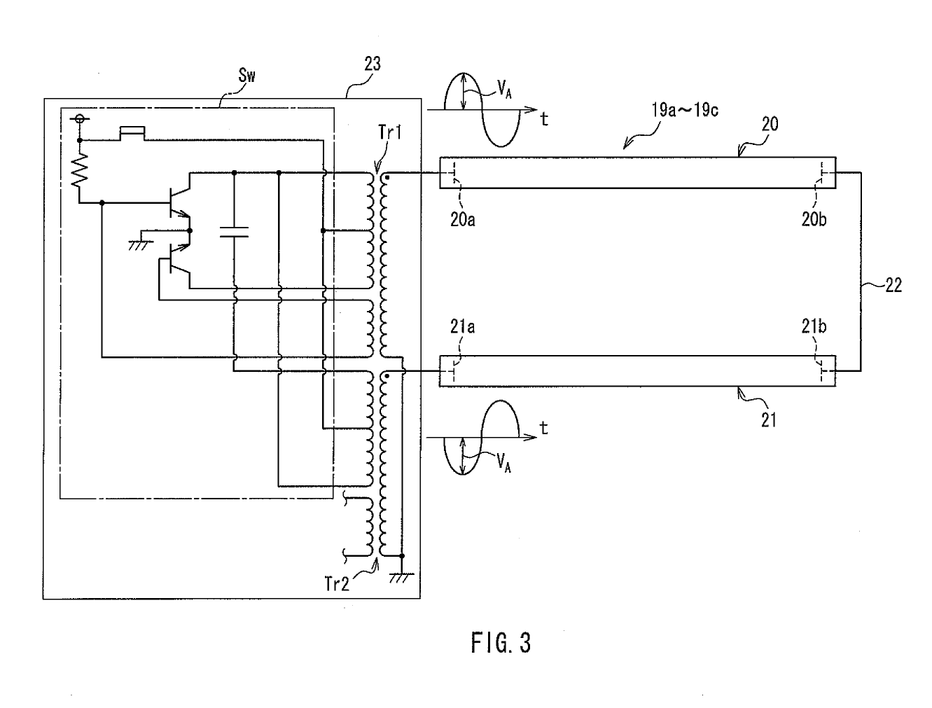

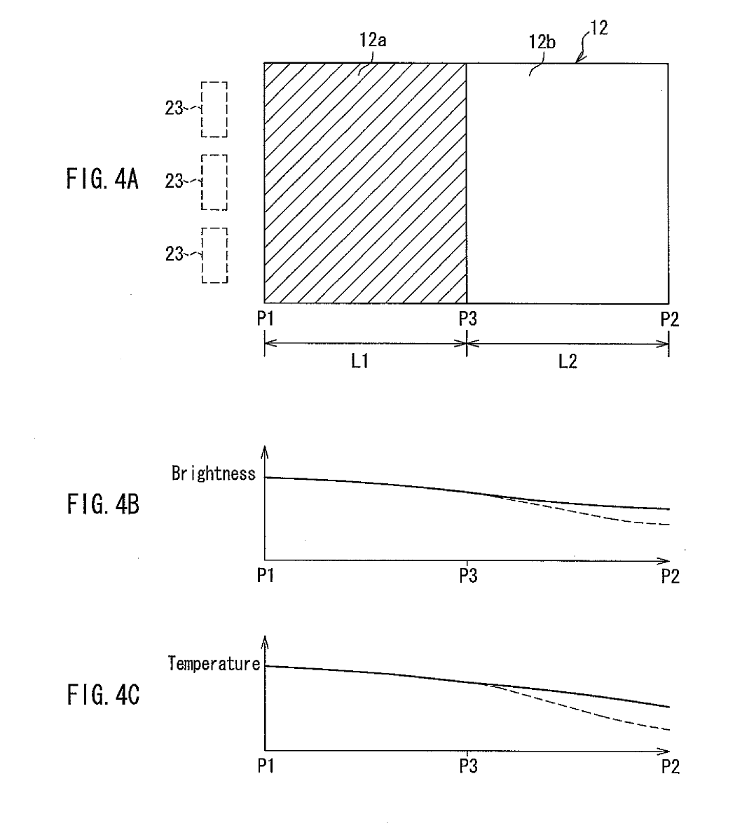

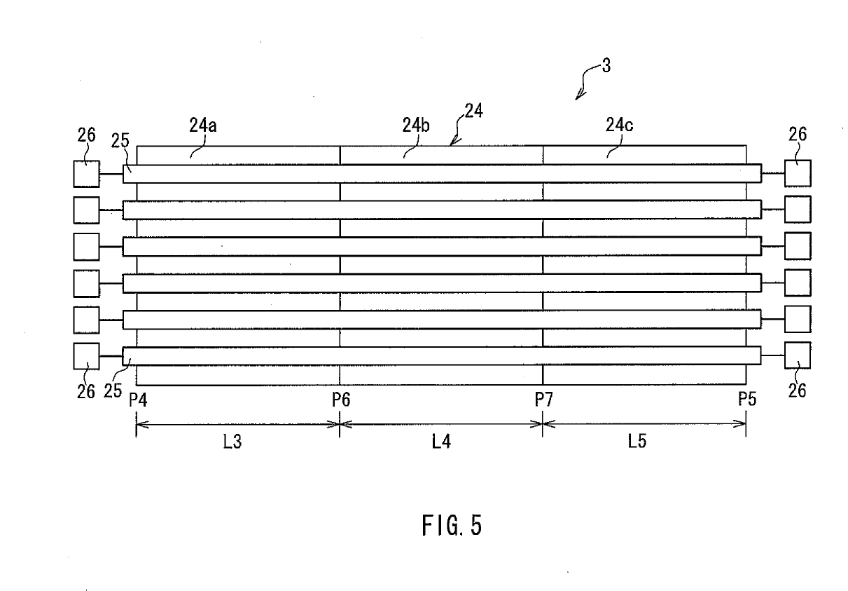

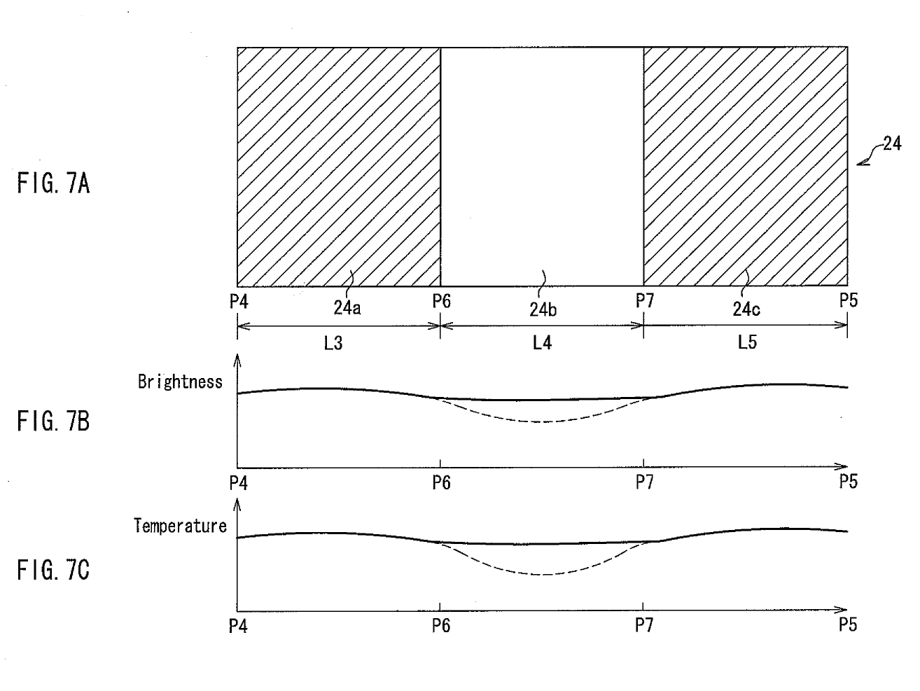

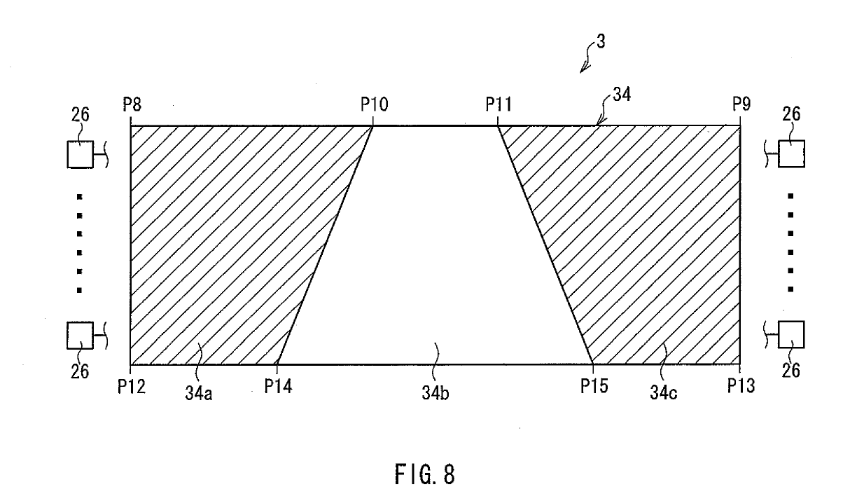

FIG. 2 is a plan view for explaining the chassis and the pseudo U-shaped tubes provided in the backlight device, and FIG. 3 is a block diagram showing a driving circuit for the pseudo U-shaped tubes in a concretive manner. FIGS. 4A to 4C are diagrams for explaining effects of the chassis. FIG. 4A is a plan view showing a specific configuration of the chassis, and FIGS. 4B and 4C are graphs showing a brightness distribution and a temperature distribution in the backlight device, respectively. It is to be noted that, in FIG. 2 and FIGS. 4A to 4C, only the bottom surface of the chassis 12 provided in parallel to the diffusion plate 15 is shown for the sake of brevity (the same holds true for FIG. 5, FIGS. 7A to 7C and FIG. 8, to which reference will be made later).

First, the pseudo U-shaped tubes will be described in detail with reference to FIGS. 2 and 3.

As shown in FIG. 2, three sets of pseudo U-shaped tubes 19a, 19b and 19c each include a pair of cold cathode fluorescent tubes 20 and 21 and a connection wiring 22 for electrically connecting the cold cathode fluorescent tubes 20 and 21. Each of the pseudo U-shaped tubes 19a to 19c simulates a U-shaped lamp.

Further, each of the pseudo U-shaped tubes 19a to 19c includes an inverter circuit 23 connected to the high voltage side of the cold cathode fluorescent tubes 20 and 21 to light and drive the cold cathode fluorescent tubes 20 and 21, and the cold cathode fluorescent tubes 20 and 21 and the inverter circuit 23 are integrated with each other. Furthermore, in each of the pseudo U-shaped tubes 19a to 19c, the inverter circuit 23 is placed on one end side (the left end side in FIG. 2) of the cold cathode fluorescent tubes 20 and 21 in the longitudinal direction.

Straight discharge tubes are used for the cold cathode fluorescent tubes 20 and 21, and the cold cathode fluorescent tubes 20 and 21 are arranged in parallel to each other at a predetermined spacing in the vertical direction in FIG. 2. Further, the tubes used for the cold cathode fluorescent tubes 20 and 21 are thinned tubes with excellent light emission efficiency whose diameter is about 3.0 to 4.0 mm. The cold cathode fluorescent tubes 20 and 21 are held within the chassis 12 by a light source holder (not shown) while the distances from each of the cold cathode fluorescent tubes to the diffusion plate 15 and to the surface (bottom surface) of the chassis 12 are kept at predetermined distances. Furthermore, the cold cathode fluorescent tubes 20 and 21 are placed so that their longitudinal direction is parallel to a direction perpendicular to a direction of gravity.

Further, as shown in FIG. 3, the cold cathode fluorescent tubes 20 and 21 include high-voltage electrodes 20a and 21a that are connected to the inverter circuit 23 through connectors (not shown) and low-voltage electrodes 20b and 21b that are placed opposite to the high-voltage electrodes 20a and 21a. The low-voltage electrodes 20b and 21b are connected to the connection wiring 22 provided outside the lamp, so that the cold cathode fluorescent tubes 20 and 21 are connected in series. Furthermore, the cold cathode fluorescent tubes 20 and 21 are lighted at high frequency by lamp currents from the inverter circuit 23, and the lamp currents having the same amplitude (VA) but opposite phases are synchronized and then inputted to the high-voltage electrodes 20a and 21a.

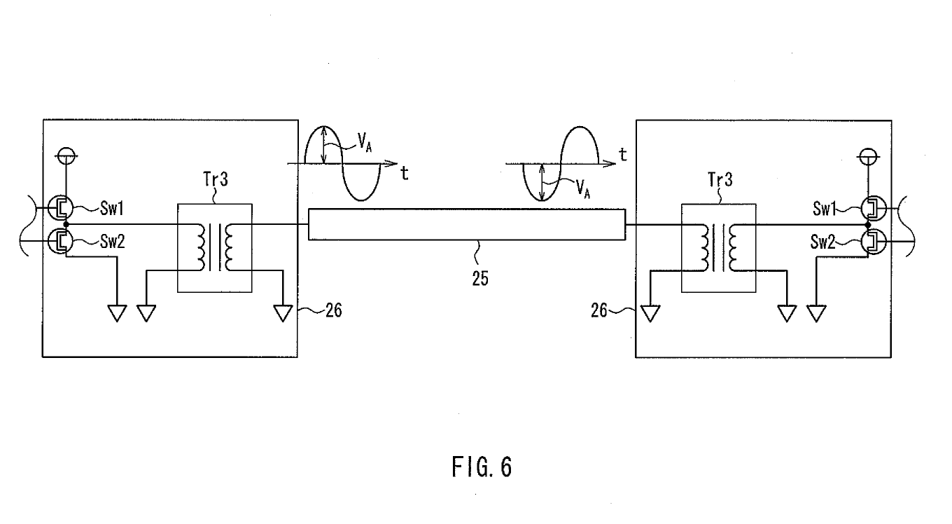

Each of the inverter circuits 23 includes identical first and second transformers Tr1 and Tr2 for outputting the lamp currents to the cold cathode fluorescent tubes 20 and 21, respectively, and a control circuit Sw for controlling the driving of the transformers Tr1 and Tr2. As shown in FIG. 6, the control circuit Sw includes a switching portion using two transistors, and electronic components such as a capacitor. An IC on which the electronic components are integrated is used for the control circuit Sw. Each of the inverter circuits 23 controls the driving of the corresponding pseudo U-shaped tubes 19a to 19c by PWM dimming, for example.

Next, the chassis 12 will be described in detail with reference to FIG. 2 and FIGS. 4A to 4C.

As shown in FIGS. 2 and 4A, the chassis 12 includes a metal chassis part 12a made of metal such as aluminum or iron and a resin chassis part 12b made of a synthetic resin such as a PC (polycarbonate) resin. On the surfaces of the metal chassis part 12a and the resin chassis part 12b on the display surface side (i.e., the bottom surface of the chassis), a reflecting layer H that reflects light from the cold cathode fluorescent tubes 20 and 21 towards the diffusion plate 15 is provided. Thus, light emitted by the cold cathode fluorescent tubes 20 and 21 can be reflected efficiently towards the diffusion plate 15, so that the usage efficiency of the light and the brightness of the light at the diffusion plate 15 can be improved.

A reflecting sheet material made of a PET (polyethylene terephthalate) synthetic resin, for example, is used for the reflecting layer H. It is to be noted that, in addition to this example, the reflecting layer H may be formed by applying a coating, for example, a white coating having a high light reflectivity to the surfaces of the metal chassis part 12a and the resin chassis part 12b on the display surface side.

Further, the metal chassis part 12a is used for a section of the chassis 12 including a predetermined distance from the inverter circuits 23 in the longitudinal direction (horizontal direction in FIG. 2) of the cold cathode fluorescent tubes 20 and 21 and the resin chassis part 12b is used for a section of the chassis 12 beyond the predetermined distance. To be more specific, as indicated by the hatched section and the non-hatched section in FIG. 4A, the metal chassis part 12a and the resin chassis part 12b are provided integrally on the left end side and the right end side of the chassis 12 in the drawing. With regard to the metal chassis part 12a and the resin chassis part 12b, the predetermined distance is set to ½ of the length of the chassis 12 in the longitudinal direction, for example. Thus, the metal chassis part 12a and the resin chassis part 12b formed in the same shape are used. In other words, the metal chassis part 12a is used for a section of the chassis 12 including a distance L1 between a left end P1 and a midpoint P3 in the longitudinal direction. Further, the resin chassis part 12b is used for a section of the chassis 12 including a distance L2 between the midpoint P3 and a right end P2 in the longitudinal direction. The distances L1 and L2 are the same.

As described above, the chassis 12 includes the metal chassis part 12a and the resin chassis part 12b. By changing the shape (size) of the metal chassis part 12a and the shape (size) of the resin chassis part 12b, the amount of leakage current generated due to parasitic capacitances between each of the cold cathode fluorescent tubes 20 and 21 and the chassis 12 can be adjusted. That is, since no leakage current is generated in the resin chassis part 12b, the amount of leakage current to be generated can be adjusted by changing the shape of the resin chassis part 12b with relative to the entire chassis 12. As a result, in the backlight device 3 of the present embodiment, it is possible to inhibit a brightness gradient resulting from the leakage current.

To be more specific, in the backlight device 3 of the present embodiment, as indicated by the solid line in FIG. 4B, each of the cold cathode fluorescent tubes 20 and 21 is configured so as to make a brightness gradient to be mildly curved in the section from the midpoint P3 to the right end P2 than in the section from the left end P1 to the midpoint P3. As a result, the brightness gradient in the longitudinal direction and changes in the brightness due to the brightness gradient can be reduced. Further, when the entire chassis 12 is formed without using the resin chassis part 12b and is formed solely of the metal chassis part 12a, the brightness gradient in the section from the midpoint P3 to the right end P2 and in the section from the left end P1 to the midpoint P3 becomes almost the same, resulting in a large change in the brightness between the left end P1 and the right end P2.

In contrast, the leakage current is generated in the metal chassis part 12a. Therefore, the starting voltage of the cold cathode fluorescent tubes 20 and 21 can be reduced. In other words, in the backlight device 3 of the present embodiment, by providing the metal chassis part 12a on the side where the inverter circuits 23 are provided, the leakage current can be generated in the metal chassis part 12a to significantly reduce voltages supplied to the cold cathode fluorescent tubes 20 and 21 at the beginning of lighting (i.e., starting voltage). Consequently, since voltages loaded to the transformers Tr1 and Tr2 included in each of the inverter circuits 23 can be reduced at the beginning of lighting of the cold cathode fluorescent tubes 20 and 21, there is no need to increase the dielectric strength of the inverter circuits 23 unnecessarily. As a result, compact circuits can be used for the inverter circuits 23.

Further, as shown in FIG. 4C, the temperature distribution in the chassis 12 in the longitudinal direction is substantially uniform in the present embodiment. This is because the radiation capacity of the resin chassis part 12b is smaller (higher heat insulation) than that of the metal chassis part 12a. That is, in the present embodiment, since the metal chassis part 12a is provided on the side where the inverter circuits 23 as heat sources and the high-voltage electrodes 20a and 21a having a relatively large amount of heat generation are placed, and the resin chassis part 12b is provided on the side where the low-voltage electrodes 20b and 21b having a relatively small amount of heat generation are placed, the temperature distribution in the longitudinal direction is kept substantially uniform. In other words, when the chassis 12 is formed entirely of the metal chassis part 12a, as indicated by the dashed line in FIG. 4C, heat is dissipated in a similar manner in the section from the midpoint P3 to the right end P2 and in the section from the left end P1 to the midpoint P3, resulting in a large change in the temperature between the left end P1 and the right end P2. In contrast, in the present embodiment, the temperature distribution can be made substantially uniform due to using the resin chassis part 12b. Furthermore, since the temperature distribution in the longitudinal direction in the chassis 12 of the present embodiment can be made substantially uniform in this way, variations in the light emission efficiency caused by the ambient temperature of the cold cathode fluorescent tubes 20 and 21 can be inhibited, and changes in the brightness in the longitudinal direction can be reduced.

Furthermore, the temperature distribution in the longitudinal direction can be made substantially uniform in the present embodiment as described above. Thus by reducing a temperature difference of each of the cold cathode fluorescent tubes 20 and 21 in the longitudinal direction, a significant decrease in the life spans of the cold cathode fluorescent tubes 20 and 21 can be prevented. That is, as the temperature difference of each of the cold cathode fluorescent tubes 20 and 21 in the longitudinal direction is improved, mercury charged in the cold cathode fluorescent tubes 20 and 21 is prevented extensively from concentrating at the coldest spot. Thus, by preventing the mercury from leaning on one side, a decrease in the life spans of the cold cathode fluorescent tubes 20 and 21 can be prevented significantly.

In the backlight device 3 of the present embodiment configured in the above-described manner, the chassis 12 includes the metal chassis part 12a and the resin chassis part 12b. Further, the metal chassis part 12a is used for the section including the predetermined distance from the inverter circuits (driving circuits) 23 in the longitudinal direction of the cold cathode fluorescent tubes (discharge tubes) 20 and 21, and the resin chassis part 12b is used for the section beyond the predetermined distance. Thus, in the backlight device 3 of the present embodiment, it is possible to prevent the occurrence of the leakage current in the resin chassis part 12b, in other words, the section beyond the predetermined distance. Consequently, unlike the conventional backlight devices described above, the backlight device 3 of the present embodiment can inhibit a brightness gradient resulting from the leakage current and make the brightness of illumination light uniform with ease, as shown in FIG. 4B.

Further, since the liquid crystal display device 1 of the present embodiment uses the backlight device 3 capable of inhibiting the brightness gradient resulting from the leakage current and of making the brightness of illumination light uniform with ease, it is possible to form the liquid crystal display device 1 having excellent display quality with ease.

In the above, the case of setting the predetermined distance to ½ of the length of the chassis in the longitudinal direction of the cold cathode fluorescent tubes 20 and 21 and using the metal chassis part 12a and the resin chassis part 12b having the same shape has been described. However, the metal chassis part and the resin chassis part of the present embodiment are not limited to this configuration, and the shape of the metal chassis part and the resin chassis part can be changed appropriately in accordance with the material and thickness of the metal chassis part and the resin chassis part, the type of the cold cathode fluorescent tubes, the amount of power (driving power) supplied from the inverter driving circuits, etc (the same holds true for each embodiment described later).

### Embodiment 2

FIG. 5 is a plan view for explaining a chassis and cold cathode fluorescent tubes in a backlight device according to Embodiment 2 of the present invention, and FIG. 6 is a block diagram showing driving circuits for the cold cathode fluorescent tubes in a concretive manner. In the drawings, the major differences between the present embodiment and Embodiment 1 are that cold cathode fluorescent tubes each including inverter circuits connected to both ends thereof are used in place of the pseudo U-shaped tubes, and a resin chassis part is used for the middle section of the chassis in the longitudinal direction of the cold cathode fluorescent tubes and metal chassis parts are used for both end sides of the cold cathode fluorescent tubes so as to interpose the resin chassis part. Components common to those in Embodiment 1 are denoted by the same reference numerals and the description thereof will not be repeated.

That is, as shown in FIG. 5, six cold cathode fluorescent tubes 25 are arranged in the backlight device 3 of the present embodiment so that their longitudinal direction (horizontal direction in FIG. 5) becomes parallel to a direction perpendicular to the direction of gravity. Further, inverter circuits 26 as driving circuits are connected to left and right ends of each cold cathode fluorescent tube 25 and power is supplied to each cold cathode fluorescent tube 25 from the inverter circuits 26 at the left and right ends.

To be more specific, as shown in FIG. 6, each inverter circuit 26 includes a transformer Tr3, and transistors Sw1 and Sw2 provided on the primary winding side of the transformer Tr3. Further, in each inverter circuit 26, an electrode (not shown) of the cold cathode fluorescent tube 25 is connected to the secondary winding side of the transformer Tr3, and lamp currents having the same amplitude (VA) but opposite phases are synchronized and then inputted to each cold cathode fluorescent tube 25 from the inverter circuits 26 on the left and right sides.

Further, metal chassis parts 24a and 24c are used for sections of the chassis 24 respectively including predetermined distances from the respective inverter circuit 26 in the longitudinal direction of the cold cathode fluorescent tubes 25 (horizontal direction in FIG. 5) and a resin chassis part 24b is used for the section of the chassis 24 beyond the predetermined distances and interposed between the metal chassis parts 24a and 24c. Similarly to Embodiment 1, the metal chassis parts 24a and 24c and the resin chassis part 24b are provided with the reflecting layer (not shown) to improve the light utilization efficiency of the cold cathode fluorescent tubes 25.

Here, the chassis 24 will be described in detail with reference to FIG. 7.

FIGS. 7A to 7C are diagrams for explaining effects of the chassis shown in FIG. 5. FIG. 7A is a plan view showing a specific configuration of the chassis, FIGS. 7B and 7C are graphs showing a brightness distribution and a temperature distribution in the backlight device shown in FIG. 5, respectively.

As indicated by the hatched sections in FIG. 7A, the metal chassis parts 24a and 24c are provided respectively on the left end side and the right end side of the chassis 24 in the drawing. Further, as indicated by the non-hatched section in FIG. 7A, the resin chassis part 24b is provided integrally with the metal chassis parts 24a and 24c on the middle section in the longitudinal direction between the metal chassis parts 24a and 24c. The predetermined distances are set to, for example, ⅓ of the length of the chassis 24 in the longitudinal direction, for example. That is, the boundary between the metal chassis part 24a and the resin chassis part 24b is set to ⅓ of the length of the chassis 24 in the longitudinal direction from the inverter circuit 26 on the left side. Likewise, the boundary between the metal chassis part 24c and the resin chassis part 24b is set to ⅓ of the length of the chassis 24 in the longitudinal direction from the inverter circuit 26 on the right side. That is, the metal chassis parts 24a and 24c and the resin chassis part 24b, all of which have the same shape, are used.

Specifically, the metal chassis part 24a is used for the section of the chassis 24 including a distance L3 between a left end P4 and a point P6 in the longitudinal direction. Further, the resin chassis part 24b is used for the section of the chassis 24 including a distance IA between the point P6 and a point P7 in the longitudinal direction. The metal chassis part 24c is used for the section of the chassis 24 including a distance L5 between the point P7 and a right end P5 in the longitudinal direction. The distances L3 to L5 are the same.

As described above, in the backlight device 3 of the present embodiment, the resin chassis part 24b is used for the middle section of the chassis 24 in the longitudinal direction of the cold cathode fluorescent tubes 25, and the metal chassis parts 24a and 24c are used for the both end sides of the cold cathode fluorescent tubes 25 so as to interpose the resin chassis part 24b. Thus, similarly to Embodiment 1, a brightness gradient can be inhibited by preventing the occurrence of the leakage current in the middle section. Specifically, as indicated by the solid line in FIG. 7B, a decline in the brightness can be inhibited with more certainty than using a metal chassis part for the section between the point 6 and the point 7 (indicated by the dashed line in the drawing).

Further, the resin chassis part 24b has higher heat insulation than the metal chassis parts 24a and 24c. Thus, as shown in the solid line in FIG. 7C, a decline in the temperature can be inhibited with more certainty than using a metal chassis part for the section between the point 6 and the point 7 (indicated by the dashed line in the drawing), so that the temperature distribution in the chassis 24 can be made substantially uniform.

Further, in the backlight device 3 of the present embodiment, the resin chassis part 24b is used for the middle section in the longitudinal direction of the cold cathode fluorescent tubes 25 and the metal chassis parts 24a and 24c are used for the both end sides of the cold cathode fluorescent tubes 25 so as to interpose the resin chassis part 24b. Thus, even when the cold cathode fluorescent tubes 25 having a long length are used, it is possible to prevent, with certainty, the occurrence of the leakage current in the middle section in the longitudinal direction. As a result, in the backlight device 3 of the present embodiment, even when the cold cathode fluorescent tubes 25 having a long length are used to respond to an increase in the screen size of the liquid crystal display device 1, a decline in the brightness in the middle section resulting from the brightness gradient can be prevented with ease and the brightness of illumination light can be made uniform with ease.

### Embodiment 3

FIG. 8 is a plan view for explaining a chassis in a backlight device according to Embodiment 3 of the present invention. In the drawing, the major difference between the present embodiment and Embodiment 2 is that the shapes of metal chassis parts and the shape of the resin chassis part in the chassis are defined by using a temperature distribution in the chassis during the backlight device is in active use. It is to be noted that components common to those in Embodiment 2 are denoted by the same reference numerals and the description thereof will not be repeated.

That is, as shown in FIG. 8, in the backlight device 3 of the present embodiment, the shapes of metal chassis parts 34a and 34c and the shape of a resin chassis part 34b are defined by using a temperature distribution in a chassis 34 during the liquid crystal display device 1 is in active use. To be more specific, in the backlight device 3, the temperature distribution in the chassis 34 during the liquid crystal display device 1 is in active use has been determined in advance through actual measurement, simulation, etc. and it has been confirmed that the upper section located on the upper side in the normal direction (vertical direction in FIG. 8) when the liquid crystal display device 1 is in active use has a temperature higher than the lower section located on the lower side in the normal direction.

In the chassis 34, as shown in FIG. 8, the shapes of the metal chassis part 34a and 34c and the shape of the resin chassis part 34b are defined on the basis of the confirmed temperature distribution. Similarly to Embodiment 2, the metal chassis parts 34a and 34c and the resin chassis part 34b are provided with the reflecting layer (not shown) to improve the light utilization efficiency of the cold cathode fluorescent tubes 25.

To be more specific, in the chassis 34, the boundary point between the metal chassis part 34a and the resin chassis part 34b on the upper side where the temperature is high during the active use is set to a point P10, and the boundary point between the metal chassis part 34c and the resin chassis part 34b on the upper side is set to a point P11. Furthermore, in the chassis 34, the distance of the upper side of the metal chassis part 34a defined by the length between a left end P8 and the point 10 and the distance of the upper side of the metal chassis part 34c defined by the length between a right end P9 and the point P11 are set to be the same and also to be larger than the distance of the upper side of the resin chassis part 34b defined by the length between the point P10 and the point P11.

On the other hand, on the lower side where the temperature is low during the active use, the boundary point between the metal chassis part 34a and the resin chassis part 34b is set to a point P14 and the boundary point between the metal chassis part 34c and the resin chassis part 34b is set to a point P15. Furthermore, in the chassis 34, the distance of the lower side of the metal chassis part 34a defined by the length between the left end P12 and the point P14 and the distance of the lower side of the metal chassis part 34c defined by the length between the right end P13 and the point P15 are set to be the same and also to be smaller than the distance of the lower side of the resin chassis part 34b defined by the length between the point P14 and the point P15. As indicated by the hatched sections in FIG. 8, the substantially trapezoidal metal chassis parts 34a and 34c are provided on the left end side and the right end side in the drawing, and as indicated by the non-hatched section in FIG. 8, the trapezoidal resin chassis part 34b is provided integrally with the metal chassis parts 34a and 34c on the middle section in the longitudinal direction between the metal chassis parts 34a and 34c.

By the above configuration, the backlight device 3 of the present embodiment can achieve effects similar to those in Embodiment 2. Further, since the shapes of the metal chassis parts 34a and 34c and the shape of the resin chassis part 34b are defined by using the temperature distribution in the chassis 34 during the active use, fluctuations in the light emission efficient caused by the ambient temperature of the cold cathode fluorescent tubes 25 can be inhibited and illumination light with uniform brightness can be obtained with ease.

The above-described embodiments are shown merely for an illustrative purpose and are not limiting. The technical range of the present invention is defined by the claims, and all the changes within a range equivalent to the configuration recited in the claims also are included in the technical range of the present invention.

For example, although the case where the present invention is applied to a transmissive liquid crystal display device has been described above, the application of the backlight device of the present invention is not limited to this type. For example, the backlight device of the present invention can be applied to a variety of display devices including a non-luminous display portion that utilizes light from a light source to display information such as images and texts. More specifically, the backlight device of the present invention can be preferably applied to a semi-transmissive liquid crystal display device and a projection type display device in which light bulbs are used in the liquid crystal panel.

In addition to the examples described above, the present invention can be preferably applied to an X illuminator used to irradiate x-ray radiographs with light, a light box that irradiates negative images or the like with light to make them more visually identifiable or a backlight device of a light-emitting device for illuminating billboards or ads placed on walls in station premises.

Although the case of using cold cathode fluorescent tubes has been described above, the discharge tube of the present invention is not limited to cold cathode fluorescent tubes. For example, other types of discharge fluorescent tubes, such as a hot cathode fluorescent tube and a xenon fluorescent tube, and non-straight discharge fluorescent tubes, such as a U-shaped tube other than a pseudo U-shaped tube, may also be used.

That is, the present invention only needs to be a backlight device including: a chassis for containing a discharge tube and a driving circuit connected to the discharge tube to light and drive the discharge tube, wherein the chassis includes a metal chassis part made of metal and a resin chassis part made of a synthetic resin, the metal chassis part is used for a section of the chassis including a predetermined distance from the driving circuit in a longitudinal direction of the discharge tube, and the resin chassis part is used for a section of the chassis beyond the predetermined distance. Therefore, the type and number of the discharge tube and the driving method for the discharge tube, the configuration of the driving circuit, etc. are not limited in anyway to those described above. Further, when using discharge fluorescent tubes that do not contain mercury, such as xenon fluorescent tubes as described above, a backlight device with a long life span including the discharge tubes arranged in parallel to the direction of gravity can be formed.

Further, although the case where each of the inverter circuits (driving circuits) for the three sets of pseudo U-shaped tubes is disposed on one end side of the cold cathode tubes in the longitudinal direction has been described in Embodiment 1, the present invention is not limited to this configuration. The three driving circuits may be disposed alternately on one end side and the other end side in the longitudinal direction in the direction perpendicular to the longitudinal direction. When disposing the driving circuits in this way, a metal chassis part and a resin chassis part may be provided alternately in the perpendicular direction in accordance with the arrangement of the driving circuits.

In Embodiments 2 and 3, the case where each of the straight cold cathode fluorescent tubes is driven by the two driving circuits connected to both ends thereof has been described. However, the present invention is not limited to this configuration and each of the straight cold cathode fluorescent tubes may be driven by a single driving circuit connected only to one end.

### INDUSTRIAL APPLICABILITY

The present invention is useful for a backlight device capable of inhibiting a brightness gradient resulting from a leakage current and making the brightness of illumination light uniform with ease, and a display device using the backlight device.

1. A backlight device comprising:
a discharge tube;
a chassis for containing the discharge tube; and
a driving circuit connected to the discharge tube to light and drive the discharge tube,
wherein the chassis includes a metal chassis part made of metal and a resin chassis part made of a synthetic resin,
the metal chassis part is used for a section of the chassis including a predetermined distance from the driving circuit in a longitudinal direction of the discharge tube, and the resin chassis part is used for a section of the chassis beyond the predetermined distance.

2. The backlight device according to claim 1,
wherein the driving circuits are respectively connected to both ends of the discharge tube,
the resin chassis part is used for a middle section of the chassis in the longitudinal direction of the discharge tube, and the metal chassis parts are used for both end sides of the discharge tube so as to interpose the resin chassis part.

3. The backlight device according to claim 1,
wherein, in the chassis, a shape of the metal chassis part and a shape of the resin chassis part are defined by using a temperature distribution in the chassis during the backlight device is in active use.

4. The backlight device according to claim 1,
wherein a cold cathode fluorescent tube is used for the discharge tube, and
the discharge tube is placed so that the longitudinal direction thereof becomes parallel to a direction perpendicular to a direction of gravity.

5. A display device using the backlight device according to claim 1.
